(19) United States
(12) Patent Application Publication
(10) Pub. No.: US 2009/0136070 A1
(43) Pub. Date: May 28, 2009

(54) Adaptable Connection Module of a Modular Hearing Aid

(75) Inventor: Wee Haw Koo, Singapore (SG)

Correspondence Address: LERNER GREENBERG STEMER LLP, P O BOX 2480, HOLLYWOOD, FL, 33022-2480, US

(73) Assignee: Siemens Medical Instruments Pte. Ltd., Singapore (SG)

(21) Appl. No.: 12/275,624

(22) Filed: Nov. 21, 2008

(30) Foreign Application Priority Data
Nov. 21, 2007 (DE) 10 2007 055 549.2

(51) Int. Cl. H04R 25/00

(52) U.S. Cl. 381/330

(57) ABSTRACT

A connection module for a modular hearing aid contains an interface for mechanical and electrical or acoustic coupling of the connection module to a main module which is configured to produce electrical or acoustic signals. The connection module furthermore contains a line for passing an acoustic or electrical signal to an earpiece which is configured for at least partial insertion into an auditory channel of a patient. An adaptation device is configured for adaptation of the length of a part of the line which projects out of the connection module.

### CROSS-REFERENCE TO RELATED APPLICATION

This application claims the priority, under 35 U.S.C. § 119, of German application DE 10 2007 055 549.2, filed Nov. 21, 2007; the prior application is herewith incorporated by reference in its entirety.

### BACKGROUND OF THE INVENTION

### Field of the Invention

The present invention relates to a connection module for a modular hearing aid and to a method for adaptation of a modular hearing aid to an ear of a patient. In this case, in particular, the length of a line for carrying electrical or acoustic signals to an earpiece is adapted.

U.S. Pat. No. 4,727,582 describes a behind-the-ear hearing aid in which an electroacoustic transducer which can be worn in the auditory channel is connected via a line to the appliance, which is worn behind the ear. A part of variable length of the line is arranged in a cavity in the device.

One disadvantage of this conventional hearing aid is that a cavity must be provided in the housing of the device itself which is worn behind the ear, in order to accommodate a variable component of the line to the electroacoustic transducer. This makes the hearing aid larger and more expensive. A further disadvantage is that moisture or dirt can enter the hearing aid via the cavity for holding the line. A further disadvantage is that, in the event of a defect on the line, the entire hearing aid must be transported to a repair service provider, and must be repaired there.

### SUMMARY OF THE INVENTION

It is accordingly an object of the invention to provide an adaptable connection module of a modular hearing aid that overcomes the above-mentioned disadvantages of the prior art devices of this general type, which allows easier adaptation and easier repair of the hearing aid.

With the foregoing and other objects in view there is provided, in accordance with the invention, a connection module for a modular hearing aid. The connection module contains an interface for mechanical and electrical coupling or acoustic coupling of the connection module to a main module configured for producing electrical signals or acoustic signals. A line is provided for passing the acoustic signal or the electrical signal to an earpiece configured for at least partial insertion into an auditory channel of a patient. An adaptation device is provided for adapting a length of a part of the line projecting out of the connection module.

The present invention is based on the idea of providing an adaptation device for adaptation of the length of a part of a line, which projects out of the connection module, to an earpiece, in or on a connection module for a modular hearing aid. The adaptation device is preferably configured for reversible adjustability of the length and preferably for adaptation of the length without use of any tools (screwdrivers, wrenches, etc.). The adaptation device has, for example, a fixing device for clamping or fixing, in some other way, the length of that part of the line which projects out of the connection module.

A part of the line which does not project out of the connection module can be arranged in a cavity in the connection module, for example in a spiral or coil shape, or in the form of a helix. By way of example, the cavity is formed between two housing parts of the connection module. These housing parts can be mechanically connected to one another by a latching screw connection or by some other connection which, for example, can be detached without using any tools. If the earpiece has an electroacoustic transducer, the line contains wires or braids for carrying electrical signals to the electroacoustic transducer. If sound signals are already produced in a main module which can be connected to the connection module, the line contains a sound conductor, for example an air channel.

One advantage of the invention is that the effective length of a line to an earpiece can be adjusted, and the modularity at the same time allows repair with little effort. Furthermore, the main module need no longer have any openings or cavities through which, for example, moisture or dirt could enter. The reliability of the entire hearing aid is thus considerably improved. A further advantage is that, even after replacement of the main module (for example as a result of a defect), there is no need to readjust the length of the line to the earpiece.

Other features which are considered as characteristic for the invention are set forth in the appended claims.

Although the invention is illustrated and described herein as embodied in an adaptable connection module of a modular hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a diagrammatic illustration of a modular hearing aid;

FIG. 2 is a diagrammatic, partially cut-away illustration of a connection module;

FIG. 3 is a diagrammatic, sectional illustration of the connection module;

FIG. 4 is a diagrammatic, partially cut-away illustration of the connection module;

FIG. 5 is a diagrammatic, sectional illustration of the connection module; and

FIG. 6 is a flowchart of a method for adaptation of a modular hearing aid.

### DETAILED DESCRIPTION OF THE INVENTION

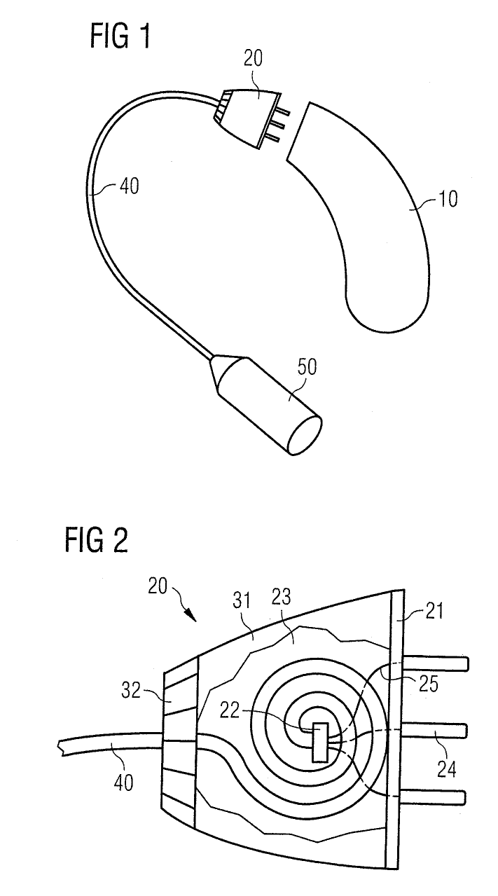

Referring now to the figures of the drawing in detail and first, particularly, to FIG. 1 thereof, there is shown a schematic illustration of a modular hearing aid. The modular hearing aid contains a main module 10 as well as a connection module 20 and an earpiece 50, which are connected to one another via a line 40. By way of example, the main module 10 contains one or more microphones, a corresponding number of amplifiers, digital or analog signal preprocessing, control elements, a battery, a rechargeable battery or some other energy source, an interface for programming, etc. Furthermore, the main module 10 contains an interface for mechanical and electrical or acoustic coupling of the main module 10 to the connection module 20. By way of example, the interface contains one or more latching, screw or bayonet connections for mechanical coupling. By way of example, the interface contains one or more electrical contacts for electrical coupling. By way of example, the interface contains an opening, to which an air channel or some other sound conductor can be acoustically coupled, for acoustic coupling.

The connection module 20 contains an interface which corresponds to the interface of the main module 10, with corresponding devices for mechanical and electrical or acoustic coupling. Furthermore, the connection module 20 contains a line 40 for carrying electrical or acoustic signals to the earpiece 50. A first end of the line 40 is coupled to the interface of the connection module 20. A part of the line 40, which is adjacent to the first end and has a variable length, is arranged in the connection module 20. A second end of the line 40 is detachably or firmly connected to the earpiece 50. The line 40 has wires or braids, or other electrical conductors for carrying an electrical signal to the earpiece 50. Alternatively or additionally, the line 40 has an air channel or some other device for carrying acoustic signals.

The earpiece 50 is configured for partial or complete insertion into an auditory channel of a patient. It is individually matched to the shape of the auditory channel or of the entry to the auditory channel of a patient, or has a shape and size which are suitable for a multiplicity of patients. An individually matched earpiece is also referred to as a matched earpiece or an otoplastic. If the interface between the main module 10 and the connection module 20 on the one hand and the line 40 on the other hand is configured in order to transmit electrical signals from the main module 10 to the earpiece 50, the earpiece 50 contains an electroacoustic transducer for conversion of electrical signals to acoustic signals or sound. If the line 40 is configured for transmission of acoustic signals to the earpiece 50, the earpiece 50 may have a device for matching the acoustic impedance of the line 40 to the acoustic impedance of the auditory channel.

FIGS. 2 to 5 show schematic illustrations of various variants of the connection module 20 which can be coupled to a corresponding main module 10, in each case as described above with reference to FIG. 1. Devices for mechanical coupling of the connection module 20 to the main module 10 are not illustrated in FIGS. 2 to 5. The line 40 which is connected to the connection module 20, and the earpiece 50 which is connected to the line 40, are not illustrated in FIGS. 2 to 5, respectively.

FIG. 2 shows a connection module 20 with a first housing part 21 and a second housing part 31. A line holder 22 and contacts 24 are arranged on the first housing part 21. The line holder 22 holds or is mechanically connected to the first end of the line 40. The contacts 24 form the electrical part of the interface of the connection module 20 to the main module 10. By way of example, the contacts 24 are in the form of pins or tongues. Connection wires 25 or other electrically conductive components connect the contacts 24 to the line 40. The second housing part 31 is shown in FIG. 2 as being (partially) transparent, so that the line holder 22, the connection wires 25 and the part of the line 40 which is arranged in the connection module 20 can be seen.

A fixing device 32 or a “locking gate” is arranged on a side of the second housing part 31 facing away from the first housing part 21. The fixing device 32 contains, for example, a clamping device for clamping fixing of the length of that part of the line 40 which projects out of the connection module 20, or another mechanism for fixing this length. The clamping or other fixing of the length of that part of the line 40 which projects out of the connection module 20 is achieved, for example, by rotation or linear movement, or else just by pushing on and connection of the second housing part 31 to the first housing part 21. By way of example, the second housing part 31 has grooves in order to make it easier to grip it. Alternatively, the fixing device 32 contains a component which can be moved with respect to the second housing part 31 and may have corresponding grooves.

Between the first housing part 21 and the second housing part 31, the connection module 20 has a cavity 23 in which the line holder 22 is arranged. That part of the line 40 which is arranged in the connection module 20 is arranged in a spiral shape in the cavity 23.

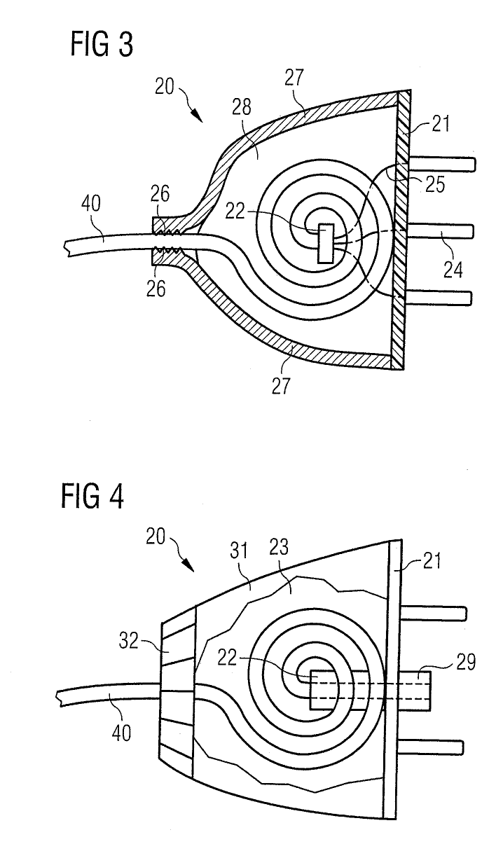

FIG. 3 shows a schematic illustration of the connection module 20 with the first housing part 21 and the second housing part, which is not illustrated in FIG. 3. The line holder 22 and the contacts 24 are firmly connected to or arranged on the first housing part 21, and the contacts 24 form an electrical part of an interface between the connection module 20 and the main module 10, which is not illustrated in FIG. 3. The contacts 24 are connected by the connection wires 25 to an end of the line 40 which is held by the line holder 22. The first housing part 21 is also firmly connected to supports 27, clamping jaws 26 arranged thereon, and a plate or wall 28, or is formed integrally with them. The support 27 and the wall 28 are arranged together in the form of a trough, with FIG. 3 illustrating the view of the open side of the trough. The line holder 22, the connection wires 25 and that part of the line 40 which is arranged in the connection module 20 and is in the form of a spiral are arranged in the trough which is formed by the support 27 and the wall 28. The line holder 22 is firmly connected to the wall 28, or is formed integrally with it.

The clamping jaws 26 are elastically connected to those ends of the support 27 which face away from the interface to the main module 10, or are formed integrally with them. The clamping jaws 26 and a second housing part, which is not illustrated in FIG. 3, are, for example, configured such that the two clamping jaws are compressed and the line 40 arranged between them is clamped by fitting or locking the second housing part to the first housing part, which is illustrated in FIG. 3. The clamping effect can be enhanced by grooves on one or both clamping jaws 26.

FIG. 4 shows a schematic illustration of the connection module 20 which differs from the connection module 20 described above with reference to FIG. 2 in that it is configured to transmit an acoustic or sound signal from a main module to an earpiece. A piece of tubing 29 projects out of the first housing part 21 and forms an acoustic part of an interface to a main module 10. The piece of tubing 29 is extended into the cavity 23 of the connection module 20, where it forms the line holder 22. A fixing device for fixing the length of that part of the line 40 which projects out of the connection module 20 can be configured, for example, according to one of the variants described above with reference to FIGS. 2 and 3.

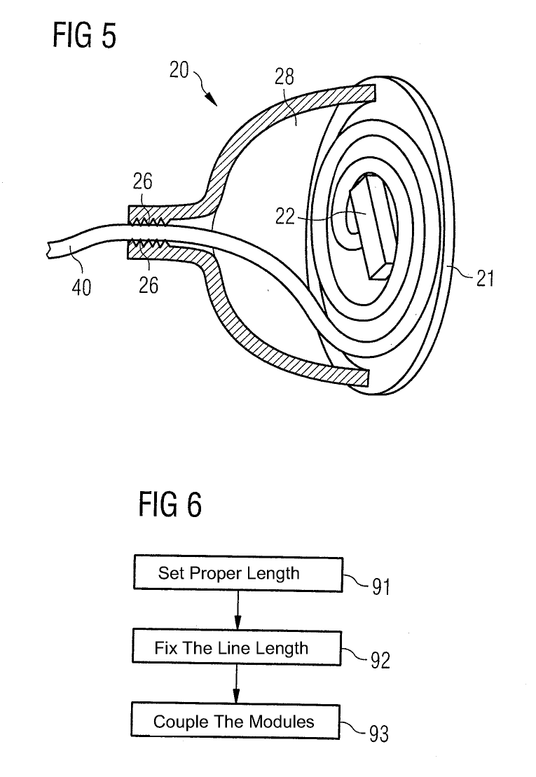

FIG. 5 shows a schematic illustration of the connection module 20 with the first housing part 21 and the second housing part, which is not illustrated in FIG. 5. The first housing part 21 has an interface, which is not illustrated in FIG. 5, for mechanical and electrical or acoustic coupling of the connection module 20 to a main module. A wall 28 is firmly connected to the first housing part 21, or is formed integrally, and partially surrounds a cavity 23 within the connection module 20. Clamping jaws 26 are elastically connected to the wall 28. In a similar manner to that described above with reference to FIG. 3, the clamping jaws 26 can be compressed by fitting or locking the second housing part, which is not illustrated in FIG. 5, to the first housing part 21, in order in this way to clamp the line 40 that is located between them.

The line 40 and the interface, which is not illustrated in FIG. 5, to the main module can be configured to transmit electrical and/or acoustic signals to an earpiece. That part of the line 40 which is arranged in the connection module 20 is arranged in a spiral shape, approximately on a plane in the cavity 23, which plane is at right angles to a direction in which the connection module 20 can be connected to a main module 10.

Various features of the variants of a connection module 20 as described above can be combined with one another. For example, the clamping device which has been described above with reference to FIG. 3 can also be used for a connection module which, as described above with reference to FIG. 4, is configured for transmission of acoustic or sound signals from a main module to an earpiece. Instead of a spiral arrangement of a part of the line 40 on a plane parallel to or at right angles to a coupling direction, it is also possible to choose a helical arrangement, or an arrangement in the form of a coil or screw.

In the connection modules which have been described above with reference to FIGS. 2 and 4, the majority of the surface which is open for coupling to a main module is formed by the second housing part 31. Alternatively, the majority of the outer surface of the connection module 20 may be part of the first housing part 21, and/or may be firmly connected to the interface to the main module. In this case, for example, only the fixing device 32 and/or the area of the housing which is represented by grooves in FIG. 2 is removable or can be moved in order to fix the length of that part of the line 40 which projects out of the connection module 20.

Clamping fixing of the length of that part of the line 40 which projects out of the connection module 20 provides the capability to reversibly adjust this length. Alternatively, other mechanisms can also be provided for reversible or irreversible adjustment of the length. In a corresponding manner, the housing parts 21, 31 may be configured for repeated connection and disconnection or else be connected only once. A fixing device and a connection mechanism between the housing parts 21, 31, which can be operated without using any tools, are advantageous, although it is also possible to use connection mechanisms which require tools to be used for connection and/or for disconnection.

FIG. 6 shows a schematic illustration of a flowchart of a method for adaptation of a modular hearing aid which contains a main module, a connection module, an earpiece and a line, which projects at least partially out of the connection module, for carrying an acoustic or electrical signal to the earpiece. By way of example, the method can be applied to a modular hearing aid and in particular to a connection module as has been described above with reference to FIGS. 1 to 5. The reference symbols as used above, and as used in FIGS. 1 to 5, will be used in the following text just to simplify understanding.

In a first step 91, the length of that part of the line 40 which projects out of the connection module 20 is matched to an ear of the patient. In a second step 92, the length is fixed, for example by clamping the line 40. In a third step 93, the connection module 20 is coupled to a main module 10. This coupling includes both a mechanical and an electrical and/or an acoustic coupling.

Carrying out the third step 93 after the first step 91 and the second step 92 has the advantage that the connection module 20 can be handled more easily without the main module 10 and that the main module 10 need not yet be present in this case. Alternatively, the connection module 20 and the main module 10 may be coupled even before the first step 91 or before the second step 92.

1. A connection module for a modular hearing aid, the connection module comprising:
an interface for mechanical and one of electrical coupling and acoustic coupling of the connection module to a main module configured for producing one of electrical signals and acoustic signals;
a line for passing the acoustic signal or the electrical signal to an earpiece configured for at least partial insertion into an auditory channel of a patient; and
an adaptation device for adapting a length of a part of said line projecting out of the connection module.

2. The connection module according to claim 1, wherein said adaptation device is configured for reversible adjustability of the length of the part of said line which projects out of the connection module.

3. The connection module according to claim 1, wherein said adaptation device is configured for adjusting the length of the part of said line which projects out of the connection module without using any tools.

4. The connection module according to claim 1, wherein said adaptation device has a fixing device for fixing the length of the part of said line which projects out of the connection module.

5. The connection module according to claim 4, wherein said fixing device has a clamping device for clamping fixing of the length of the part of said line which projects out of the connection module.

6. The connection module according to claim 1, further comprising a cavity in which the part of said line is disposed.

7. The connection module according to claim 6, wherein the part of said line is disposed in said cavity in one of a spiral shape and a helical shape.

8. The connection module according to claim 1, further comprising a first housing part and a second housing part.

9. The connection module according to claim 8, wherein said first housing part and said second housing part can be repeatedly disconnected from one another and connected to one another.

10. The connection module according to claim 8, wherein said first housing part and said second housing part can be disconnected from one another and connected to one another without using any tools.

11. The connection module according to claim 8, wherein said first housing part and said second housing part are configured for one of a latching, screw and bayonet connection to one another.

12. The connection module according to claim 8, wherein said interface is disposed on said first housing part, and said adaptation device is disposed on said second housing part.

13. The connection module according to claim 8, wherein said first housing part and said second housing part are configured to fix the length of said line at a same time on connection of said first and second housing parts.

14. The connection module according to claim 1, further comprising said earpiece configured for at least partial insertion into the auditory channel of the patient.

15. The connection module according to claim 1, wherein said interface has a device for acoustic coupling, and said line contains a sound conductor.

16. The connection module according to claim 1, wherein said interface has electrical contacts and said line contains an electrical conductor.

17. A method for adaptation of a modular hearing aid containing a main module, a connection module, an earpiece, and a line projecting at least partially out of the connection module, for passing one of an acoustic signal and an electrical signal to the earpiece, with the earpiece being at least partially inserted into an auditory channel of a patient, which comprises the steps of:
adapting a length of a part of the line projecting out of the connection module to an ear of the patient;
fixing the length of the part of the line which projects out of the connection module; and
coupling at least one of mechanically, electrically and acoustically the connection module to the main module by means of an interface.

18. The method according to claim 17, which further comprises performing the adapting step so that it is reversible.

19. The method according to claim 17, which further comprises adapting the length of the line without using any tools.

20. The method according to claim 17, which further comprises disposing the part of the line in a cavity in the connection module.

21. The method according to claim 17, which further comprises disposing the line in a spiral shape in the cavity.

22. The method according to claim 17, wherein the connection module contains:
an interface for mechanical and one of electrical coupling and acoustic coupling of the connection module to the main module configured for producing one of electrical signals and acoustic signals;
the line for passing the acoustic signal or the electrical signal to the earpiece configured for at least partial insertion into the auditory channel of the patient; and
an adaptation device for adapting the length of the part of the line which projects out of the connection module.
